(19) United States
(12) Patent Application Publication
(10) Pub. No.: US 2016/0040048 A1
(43) Pub. Date: Feb. 11, 2016

(54) LIQUID EPOXY RESIN COMPOSITION AND ADHESIVE AGENT FOR HEATSINK AND STIFFENER

(71) Applicant: Shin-Etsu Chemical Co., Ltd., Tokyo (JP)

(72) Inventor: Kazuaki SUMITA, Annaka-shi (JP)

(73) Assignee: Shin-Etsu Chemical Co., Ltd., Tokyo (JP)

(21) Appl. No.: 14/819,797

(22) Filed: Aug. 6, 2015

(30) Foreign Application Priority Data
Aug. 6, 2014 (JP) 2014-160508

(51) Int. Cl. C09J 163/00

(52) U.S. Cl. CPC C09J 163/00

(57) ABSTRACT

Provided is a highly reliable adhesive agent for heatsink or stiffener, obtained by improving a conventional epoxy resin composition. The invention is a liquid epoxy resin composition exhibiting a viscosity of 50 to 1,000 Pa·s when measured by an E-type viscometer at 25° C., and including a liquid epoxy resin exhibiting a viscosity of 0.1 to 1,000 Pa·s when measured as above; a liquid phenol-based curing agent without siloxane bond and exhibiting a viscosity of 0.1 to 100 Pa·s when measured as above; a curing accelerator selected from tetraphenylphosphine, imidazole and tertiary amine; an inorganic filler treated with a silane coupling agent and exhibiting an average particle diameter of 0.1 μm or larger; thermoplastic resin particles being solid at 25° C.; and a silica treated with a silane coupling agent having a nonreactive functional group, and exhibiting an average particle diameter of not smaller than 0.005 μm but smaller than 0.1 μm.

### BACKGROUND OF THE INVENTION

1. Field of the Invention

The present invention relates to a composition for use in a heatsink or stiffener of a semiconductor chip, such as those for bonding a heat dissipation fin, a metal plate or the like to a substrate. Specifically, the invention relates to a composition that contains a particular composition(s), and is thus capable of being spread on a substrate in a favorable manner and forming a cured product superior in adhesion to the substrate.

2. Background Art

In recent years, semiconductor elements and electronic parts are made to perform high-speed operations. Thus, there has arisen a problem where a semiconductor element or electronic part malfunctions due to a large amount of heat as compared to the conventional cases. In order to remove such heat and as shown in FIG. 1, attempts have been made to attach a heatsink 1 made of a metal plate or the like to a semiconductor chip 3, particularly a CPU that is mounted on a substrate 2 through an underfill material 5. Since such heatsink 1 is usually made of a metal whose surface is bumpy in the microscopic sense, micro-gaps occur even when the semiconductor chip 3 and said heatsink 1 are in close contact with each other. For this reason, a thermal conductivity is to be improved by inserting in the micro-gaps a heat dissipation material 4 such as a thermally-conductive silicone gel, a rubber and a grease. Further, as shown in FIG. 2, attempts have also been made to attach to the substrate 2 a reinforcement plate called stiffener 8 through an adhesive agent 6. Since a stiffener is also usually made of a metal, an adhesion and adhesion stability thereof to a substrate are critical.

### DESCRIPTION OF RELATED ART

An epoxy resin-based adhesive agent (JP2006-222,406A) and a silicone rubber-based adhesive agent (JPH07-254,668A) have been mainly used to bond the heatsink 1 to the semiconductor chip 3 or the substrate 2. However, the usage of an epoxy resin-based adhesive agent leads to a larger warpage such that there occur a problem where solder balls cannot be joined at the time of performing surface mounting of a semiconductor device; and a problem where a heatsink or stiffener may be peeled off at the time of performing reflow. Meanwhile, the usage of a silicone rubber-based adhesive agent leads to a larger thermal expansion such that the micro-gaps between a semiconductor element and a heat dissipation material such as a thermally-conductive silicone gel, a rubber and a grease becomes large, thus incurring a problem where a sufficient thermal conductivity cannot be achieved.

Further, as disclosed in WO2007/029504, an epoxy resin composition made of an epoxy resin, a curing agent, a curing accelerator, an inorganic filler and thermoplastic resin particles is used as a die bond agent for semiconductor. Since this epoxy resin composition is to be used in a die bond agent for semiconductor, it has a heat resistance and an adhesion. However, even in a case where this epoxy resin composition is used as an adhesive agent for a heatsink or stiffener of a semiconductor chip, the adhesive agent will be directly exposed to a heat of the semiconductor chip when there exists no protection such as an encapsulation material. That is, a problematic reflow resistance will still be resulted even when using a high-performance die bond agent for semiconductor.

### SUMMARY OF THE INVENTION

It is an object of the present invention to provide a highly reliable adhesive agent for a heatsink and stiffener by improving a conventional epoxy resin composition.

The present invention provides a liquid epoxy resin composition exhibiting a viscosity of 50 to 1,000 Pa·s when measured by an E-type viscometer at 25° C. Particularly, the liquid epoxy resin composition includes:
(A) at least one liquid epoxy resin selected from the group consisting of a bisphenol A-type epoxy resin, a bisphenol F-type epoxy resin, a naphthalene type epoxy resin and an epoxy resin represented by the following formula (1):

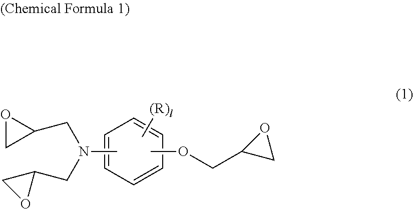

(in which, R groups are either identical to or different from each other, and each represent a hydrogen atom, a halogen atom, a substituted or unsubstituted monovalent hydrocarbon group having 1 to 6 carbon atoms, an alkoxy group or an aryl group; i represents an integer of 0 to 3), the liquid epoxy resin being in an amount of 100 parts by mass and exhibiting a viscosity of 0.1 to 1,000 Pa·s when measured by the E-type viscometer at 25° C.;
(B) a liquid phenol-based curing agent having no siloxane bond and exhibiting an viscosity of 0.1 to 100 Pa·s when measured by the E-type viscometer at 25° C., the liquid phenol-based curing agent being in an amount of 40 to 130 parts by mass with respect to 100 parts by mass of the liquid epoxy resin as the component (A);
(C) a curing accelerator selected from the group consisting of tetraphenylphosphine, imidazole and tertiary amine, the curing accelerator being in an amount of 0.1 to 20 parts by mass with respect to 100 parts by mass of the liquid epoxy resin as the component (A);
(D) an inorganic filler treated with a silane coupling agent and having an average particle diameter of not smaller than 0.1 μm, the inorganic filler being in an amount of 50 to 500 parts by mass with respect to 100 parts by mass of the liquid epoxy resin as the component (A);
(E) thermoplastic resin particles that are solid at 25° C., the thermoplastic resin particles being in an amount of 3 to 50 parts by mass with respect to 100 parts by mass of a sum of the components (A) and (B); and
(F) a silica treated with a silane coupling agent having a nonreactive functional group, the silica being in an amount of 1 to 20 parts by mass with respect to 100 parts by mass of the liquid epoxy resin as the component (A) and having an average particle diameter of not smaller than 0.005 μm but smaller than 0.1 μm.

The present invention provides an adhesive agent exhibiting a high adhesion and a high reflow resistance such that no warpage or peeling occurs at the time of performing semiconductor chip packaging. Further, improved is a heat-dissipation management property of a flip chip-type semiconductor device using such adhesive agent.

### BRIEF DESCRIPTION OF THE DRAWINGS

FIG. 1 is a cross-sectional view of a device assembled in a working example.

FIG. 2 shows an example where an adhesive agent of the present invention is used as an adhesive agent for a stiffener.

FIG. 3 is a cross-sectional view of a device assembled in a working example.

### DETAILED DESCRIPTION OF THE INVENTION

The invention is described step by step hereunder.

### (Component)

(A) Epoxy resin

Examples of an (A) epoxy resin used in the present invention include a bisphenol type epoxy resin such as a bisphenol A-type epoxy resin and a bisphenol F-type epoxy resin; an naphthalene type epoxy resin; and an epoxy resin indicated by the following formula (1). Particularly, the epoxy resin used in the present invention exhibits a viscosity of 0.1 to 1,000 Pa·s when measured by an E-type viscometer at 25° C. Further, it is preferred that such viscosity be 0.1 to 100 Pa·s.

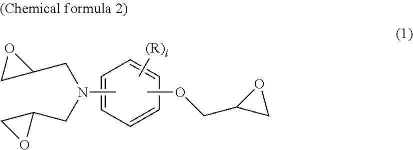

An epoxy resin exhibiting a viscosity of not higher than 0.1 Pa·s contains a large amount of low-molecular volatile components such that an adhesion and a strength of a composition may decrease. Meanwhile, an epoxy resin having a viscosity of not lower than 1,000 Pa·s may cause a viscosity of the composition to increase such that a workability thereof may be impaired significantly.

In formula (1), R represents a hydrogen atom; a halogen atom; and a group selected from a substituted or unsubstituted monovalent hydrocarbon group, alkoxy group and aryl group each having 1 to 6 carbon atoms. R may be identical to or different from one another. i represents an integer of 0 to 3. Examples of the monovalent hydrocarbon group include unsubstituted monovalent hydrocarbon groups such as methyl group, ethyl group, propyl group, butyl group, isobutyl group, tert-butyl group, isobutyl group, tert-butyl group, pentyl group, hexyl group and phenyl group. Examples of the monovalent hydrocarbon group further include substituted monovalent hydrocarbon groups such as halogen-substituted monovalent hydrocarbon groups. Specific examples of such halogen-substituted monovalent hydrocarbon groups include a chloromethyl group, a bromoethyl group and a trifluoropropyl group that are obtained by substituting a part of or all the hydrogen atoms in the aforementioned unsubstituted monovalent hydrocarbon groups with halogen atoms such as chlorine, fluorine and bromine. Here, methyl group and phenyl group are especially preferred as the monovalent hydrocarbon group.

Further, the epoxy resin in the present invention may also include a silicone-modified epoxy resin for the purpose of achieving a low stress. It is preferred that such silicone-modified epoxy resin be a silicone-modified epoxy resin made of a copolymer obtained through an addition reaction between the alkenyl group(s) of an alkenyl group-containing epoxy resin or an alkenyl group-containing phenol resin; and the SiH group(s) of the organopolysiloxane indicated by the following average compositional formula (2), provided that the organopolysiloxane has 20 to 400, preferably 30 to 200 silicon atoms in each molecule, and that such organopolysiloxane has 1 to 5, preferably 2 to 4, especially 2 hydrogen atoms directly bonded to silicon atoms (SiH groups) in each molecule.

(Chemical formula 3)

HₐR¹_{b}SiO_{(4-a-b)} (2)

(R¹ represents a substituted or unsubstituted monovalent hydrocarbon group, a is 0.01 to 0.1, b is 1.8 to 2.2, provided that 1.81≦a+b≦2.3)

It is preferred that the monovalent hydrocarbon group as R¹ be that having 1 to 10, especially 1 to 8 carbon atoms. Examples of such monovalent hydrocarbon group include alkyl groups such as methyl group, ethyl group, propyl group, isopropyl group, butyl group, isobutyl group, tert-butyl group, hexyl group, octyl group and decyl group; alkenyl groups such as vinyl group, allyl group, propenyl group, butenyl group and hexenyl group; aryl groups such as phenyl group, xylyl group and tolyl group; aralkyl groups such as benzyl group, phenylethyl group and phenyl propyl group; and halogen-substituted monovalent hydrocarbon groups such as a chloromethyl group, a bromoethyl group and a trifluoropropyl group that are obtained by substituting a part of or all the hydrogen atoms in the aforementioned hydrocarbon groups with halogen atoms such as chlorine, fluorine and bromine. Here, methyl group and phenyl group are particularly preferred as the monovalent hydrocarbon group represented by R¹.

It is desired that there be used a silicone-modified epoxy resin having a structure indicated by the following formula (3).

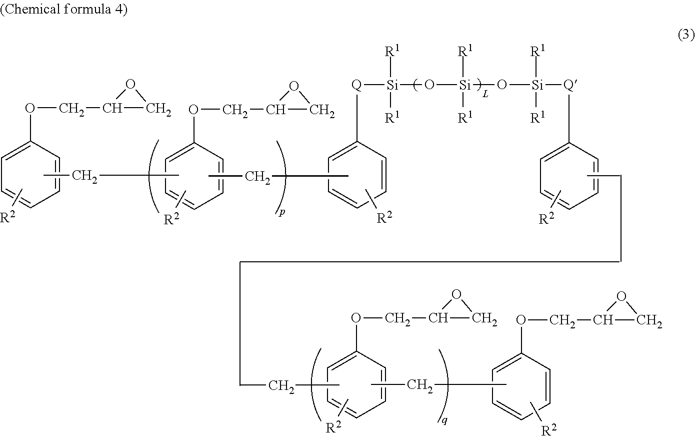

In the aforementioned formula, R¹ is identical to that of the average compositional formula (2). R² represents a hydrogen atom; or a monovalent hydrocarbon group having 1 to 6 carbon atoms such as methyl group, ethyl group, propyl group, butyl group, hexyl group and phenyl group, among which hydrogen atom, methyl group and phenyl group are preferred. Q is —CH₂CH₂CH₂—, —OCH₂—CH(OH)—CH₂—O—CH₂CH₂CH₂— or —O—CH₂CH₂CH₂—. Q′ is —CH₂CH₂CH₂—, —CH₂CH₂CH₂O—CH₂—CH(OH)—CH₂—O— or —CH₂CH₂CH₂—O—. Here, it is preferred that Q be —OCH₂—CH(OH)—CH₂—O—CH₂CH₂CH₂—, and that Q′ be —CH₂CH₂CH₂O—CH₂—CH(OH)—CH₂—O—.

L represents an integer of 8 to 398, preferably 4 to 199, more preferably 19 to 109. p represents an integer of 1 to 10, preferably 1 to 5. q represents an integer of 1 to 10, preferably 1 to 5.

If added, it is preferred that such silicone-modified epoxy resin be added in such an amount that the amount of diorganopolysiloxane contained becomes 1 to 20 parts by mass, particularly 2 to 15 parts by mass with respect to 100 parts by mass of the (A) epoxy resin, as calculated by the following formula. An amount within such ranges is preferable, since it allows a stress of a cured product to decrease, and an adhesion to a substrate to be improved.

Amount of diorganopolysiloxane=(Molecular weight of diorganopolysiloxane moiety/Molecular weight of silicone-modified epoxy resin)×Amount of silicone-modified epoxy resin added

### (B) Curing Agent

A curing agent used in the present invention is a liquid phenol resin having no siloxane bond and exhibiting a viscosity of 0.1 to 100 Pa·s when measured by an E-type viscometer at 25° C. By using such a kind of curing agent, properties such as workability, adhesion, curability and reflow resistance can be improved. Here, the reflow resistance is improved most significantly by using the above type of curing agent. Examples of such phenol resin include those of novolac-type, bisphenol-type, tris(hydroxyphenyl) methane-type, naphthalene-type, cyclopentadiene-type and phenol aralkyl-type. In fact, not only one kind, but two or more kinds of these curing agents may be used in combination.

Specifically, preferred is a liquid phenol resin exhibiting a viscosity of 0.1 to 100 Pa·s, especially 1 to 10 Pa·s when measured by an E-type viscometer at 25° C. Here, a phenol resin selected from those of bisphenol-type, novolac-type and resorcin-type is particularly preferred.

More specifically, especially preferred are the phenol resin indicated by the following structural formula (4) or (5).

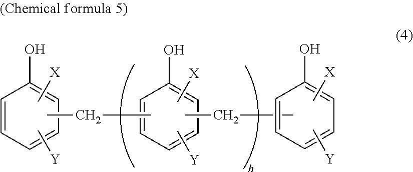

(In the above formula, X represents a hydrogen atom or a monovalent hydrocarbon group having 1 to 6 carbon atoms; Y represents a hydrogen atom or an allyl group; and h represents an integer of 0 to 50, preferably 0 to 20)

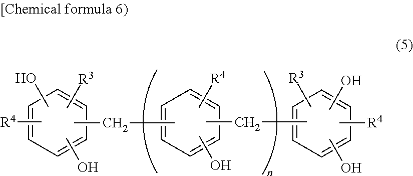

(Each of R³ and R⁴ represents a hydrogen atom and a monovalent group selected from an alkyl group, aryl group, allyl group and vinyl group each having 1 to 10 carbon atoms; n represents an integer of 0 to 10, preferably 0 to 2.)

The (B) curing agent is added in an amount of 40 to 130 parts by mass, preferably 40 to 100 parts by mass, more preferably 40 to 60 parts by mass with respect to 100 parts by mass of the component (A). An amount below such lower limit is not preferred, because an inferior curability will be achieved in such case. Moreover, an amount beyond such upper limit is also not preferred, because an inferior curability will be achieved in such case as well.

### (C) Curing Accelerator

Examples of a curing accelerator used in the present invention include a basic organic compound selected from tetraphenylphosphine, imidazole and tertiary amine. Examples of tetraphenylphosphine include tetraphenylphosphine-tetraphenylborate derivative. Examples of imidazole include: 2-methylimidazole; 2-ethylimidazole; 2-ethyl-4-methylimidazole; 2-phenylimidazole; 2-phenyl-4-methylimidazole; 2-phenyl-4-methyl-5-hydroxymethylimidazole; and 2-phenyl-4,5-dihydroxymethylimidazole. Examples of tertiary amine include triethylamine, benzyldimethylamine, α-methylbenzyldimethylamine and 1,8-diazabicyclo(5,4,0) undecene-7.

Among these curing accelerators, preferred are the tetraphenylphosphine-tetraphenylborate derivative indicated by the following formula (6); or the methylolimidazole derivative indicated by the following formula (7).

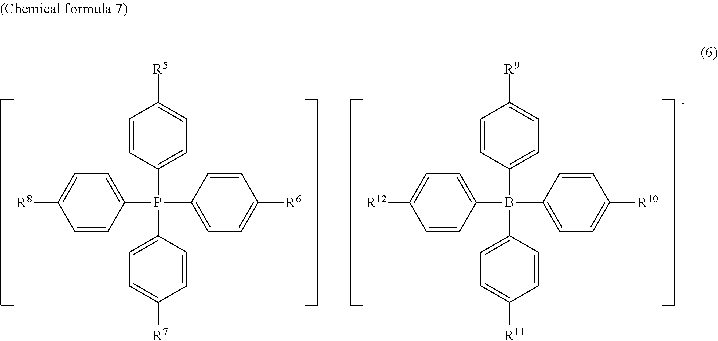

Here, each of R⁵ to R¹² independently represents a hydrogen atom; a hydrocarbon group having 1 to 10 carbon atoms; or a halogen atom.

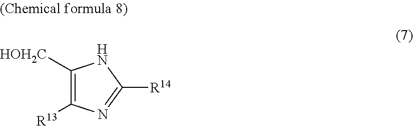

(In the above formula, R¹³ represents a hydrogen atom; or a monovalent hydrocarbon group that has 1 to 10 carbon atoms and may contain an oxygen atom, a nitrogen atom and a sulfur atom. R¹⁴ represents a hydrogen atom; or a monovalent hydrocarbon group that has 1 to 10 carbon atoms, but contains no oxygen atom, nitrogen atom and sulfur atom.)

The (C) curing accelerator is added in an amount of 0.1 to 20 parts by mass with respect to 100 parts by mass of the liquid epoxy resin as the component (A). If the curing accelerator is added in an amount below such lower limit, an adhesive composition may be cured insufficiently. Meanwhile, if the amount of the curing accelerator is beyond such upper limit, a preservability of the liquid resin composition may be impaired.

Further, it is preferred that the curing accelerator be in the form of a powder having an average particle diameter of 1 to 5 μm and exhibiting a maximum particle diameter of not larger than 20 μm. It is more preferred that such powder as the curing accelerator have an average particle diameter of 2 to 5 μm and exhibit a maximum particle diameter of not larger than 15 μm. An average particle diameter below such lower limit leads to a larger specific surface area such that a viscosity of the epoxy resin composition when mixed may increase. Moreover, an average particle diameter beyond such upper limit leads to an inhomogeneous dispersion of the curing accelerator in the epoxy resin such that a reliability may be impaired.

In addition, it is preferred that the specific surface area and particle diameter of the curing accelerator be larger than those of an (D) inorganic filler described later. Small particle diameter and specific surface area leads to an agglomeration of the powders at the time of performing mixing and kneading such that the curing agent will be dispersed inhomogeneously. That is, an undesirable curability will be achieved in such case, which may then have a negative impact on the reliability.

A purity of such curing accelerator is not lower than 90%, preferably not lower than 93%. A purity lower than 90% may lead to a variation in reactivity and then a variation in curability accordingly.

### (D) Inorganic Filler

As an (D) inorganic filler, there can be used various known inorganic fillers whose surfaces have been previously treated with a coupling agent(s). Examples of such inorganic filler include molten silica, crystalline silica, alumina, boron nitride, aluminum nitride, silicon nitride, magnesia, magnesium silicate and aluminum. Here, a spherical molten silica is preferred due to the fact that the viscosity of the composition will decrease if using the same.

It is preferred that a silane coupling agent, a titanate coupling agent or the like be used as a coupling agent for treating the surface of an inorganic filler. The coupling agent is used to improve a coupling strength between the inorganic filler and resin. Examples of such coupling agent include silane coupling agents such as those of epoxy silanes and those of amino silanes. Specifically, examples of such epoxy silane include γ-glycidoxypropyltrimethoxysilane, γ-glycidoxypropylmethyldiethoxysilane and β-(3,4-epoxycyclohexyl)ethyltrimethoxysilane. Examples of such amino silane include N-β(aminoethyl)-γ-aminopropyltrimethoxysilane, γ-aminopropyltriethoxysilane and N-phenyl-γ-aminopropyltrimethoxysilane.

An amount of the coupling agent added for surface treatment and a surface treatment method itself also depend on a surface area of the (D) inorganic filler. In general, the coupling agent is added in an amount of 0.1 to 5.0 parts by mass, more preferably 0.1 to 3.0 parts by mass with respect to 100 parts by mass of the (D) inorganic filler. Moreover, a surface treatment can be performed on the inorganic filler through wet or dry processing.

It is desired that the inorganic filler have an average particle diameter of 0.1 to 10 μm and exhibit a maximum particle diameter of 5 to 75 μm, especially 5 to 50 μm. An average particle diameter below such lower limit leads to an increase in viscosity of the composition such that the inorganic filler may not be able to be used in a large amount. Meanwhile, an average particle diameter beyond such upper limit may cause voids to be formed inside the cured product. In the present invention, particle diameters are obtained through a laser diffraction method, and an average particle diameter refers to a weight average value (or median diameter d₅₀).

The (D) inorganic filler is added in an amount of 30 to 1,000 parts by mass, preferably 40 to 400 parts by mass, more preferably 50 to 300 parts by mass with respect to 100 parts by mass of the component (A). An amount of the (D) inorganic filler that is below such lower limit is not preferred, because a large expansion coefficient of the cured product will be achieved in such case, and cracks may be induced thereby. Further, an amount of the (D) inorganic filler that is beyond such upper limit is not preferred either, because the composition will exhibit an excessively high viscosity in such case.

### (E) Thermoplastic Resin Particles

Thermoplastic resin particles (E) used in the present invention are solid at 25° C. As such thermoplastic resin particles, there can be used known resin particles such as methacrylic resin particles, phenoxy resin particles, polybutadiene resin particles, polystyrene particles and copolymers thereof. Further, the thermoplastic resin particles may be those having a core/shell structure where each particle's inner core part (core) and outer coat part (shell) are composed of different types of resins. In such case, it is desired that the core be a rubber particle made of, for example, a silicone resin, a fluorine resin or a butadiene resin, and that the shell be composed of the various thermoplastic resins that are described above and comprise linear molecular chains.

The particle shape of the thermoplastic resin particles may, for example, be a substantially spherical shape, a column shape, a rectangular column shape, an indefinite shape, a fragment shape or a scale shape. Here, a substantially spherical shape and an indefinite shape having no sharp angle portion are preferred, provided that the present invention is to be used as an adhesive agent.

An average particle diameter of such thermoplastic resin particles is appropriately determined based on an intended use of the invention. However, in general, it is desired that the thermoplastic resin particles exhibit a maximum particle diameter of not larger than 10 μm, especially not larger than 5 μm; and have an average particle diameter of 0.1 to 5 μm, especially 0.1 to 2 μm. When the maximum particle diameter is beyond such upper limit, or when the average particle diameter is larger than 5 μm, the resin thickness will increase such that the warpage of a semiconductor device becomes significant and that this semiconductor device may not be able to exhibit its functions accordingly. Further, when the average particle diameter is below such lower limit, the composition will exhibit a larger viscosity such that the workability may be considerably impaired.

The thermoplastic resin particles may have a cross-linked structure. However, since it is considered preferable to form a structure where the thermoplastic resin (E) is homogenously dispersed in a network structure of an epoxy resin, a low cross-linkage degree is preferred, and a linear molecular chain without a cross-linkage is more preferred.

The molecular weight of the thermoplastic resin particles is appropriately determined based on the kind of a resin. Typically, their number average molecular weight measured through gel permeation chromatography (GPC) is 1,000 to 10,000,000, preferably 10,000 to 100,000 in terms of polystyrene. And, their weight-average molecular weight measured through gel permeation chromatography (GPC) is 10,000 to 100,000,000, preferably 100,000 to 1,000,000 in terms of polystyrene. A number average molecular weight below such lower limit or a weight-average molecular weight below the above lower limit leads to an excessively low temperature at which swelling takes place such that a stability of the composition may be impaired. Meanwhile, when a number average molecular weight is beyond such upper limit or a weight-average molecular weight is beyond its upper limit, a temperature at which swelling takes place increases. In such case, there exists a small difference from a temperature at which the C stage occurs. Thus, a volume resistance may increase as a result of an insufficient swelling.

The number average molecular weight and the weight-average molecular weight in the present invention, refer to a number average molecular weight and a weight-average molecular weight that are measured through gel permeation chromatography (GPC) under the following conditions, using polystyrene as a reference substance.

Conditions for measurement by GPC are as follows.

Developing solvent: THF
Flow rate: 0.2 mL/min
Detector: Differential refractive index detector (RI)
Column: TSK Guardcolumn Super HZ-L (4.6 mm×2 cm), TSKgel Super HZ4000 (4.6 mm ID×15 cm×1), TSKgel Super HZ3000 (4.60 mm ID×15 cm×1), TSKgel Super HZ2000 (4.60 mm ID×15 cm×2) (All produced by Tosoh Corporation) Column temperature: 40° C.
Injected amount of sample: 5 μL (THF solution of a concentration of 0.5% by weight)

It is preferred that the thermoplastic resin particles be contained in an amount of 1 to 30 parts by mass, more preferably 3 to 20 parts by mass with respect to 100 parts by mass of a sum of the components (A) and (B). Here, a contained amount beyond such upper limit leads to an increased viscosity such that the workability may be impaired. Further, a smaller contained amount may cause an adhesive force to decrease significantly.

(F) Inorganic Filler Surface-Treated with Silane Coupling Agent Having Nonreactive Functional Group

As an inorganic filler surface-treated with a nonreactive organic silicon compound, there can be favorably used those obtained by surface treating a fumed silica or a wet silica with, for example, CH₃Si(OCH₃)₃, (CH₃)₃SiOCH₃, PhSi(OCH₃)₃, PhSiCH₃(OCH₃)₂, {(CH₃)₃Si}₂NH and CH₃CH₂Si(OCH₃)₃ (“Ph” refers to phenyl group). Examples of such fumed silica include Aerosil 130, Aerosil 200 and Aerosil 300 (by Nippon Aerosil Co., Ltd.); and examples of such wet silica include Nipsil VN-3-LP (by Tosoh Silica Corporation).

The composition of the present invention also uses such inorganic filler surface-treated with a silane coupling agent having a nonreactive functional group(s), from the perspective of workability. Here, an average particle diameter of such filler is not smaller than 0.005 μm, but smaller than 0.1 μm, preferably within a range of 0.008 to 0.08 μm. An average particle diameter below such lower limit leads to an increased viscosity of the composition such that the workability thereof may be significantly impaired. Moreover, an average particle diameter beyond such upper limit may to lead to a phenomenon where the composition comes into contact with an element(s) on a substrate; or a phenomenon where the composition protrudes from an edge portion of a heatsink.

As for surface treatment, an inorganic filler may be treated with the nonreactive organic silicon compound in advance. Further, surface treatment may also be performed through an integral blending method where the nonreactive organic silicon compound is added at the time of preparing the composition of the present invention. The former is preferred in terms of restricting the amount of the nonreactive organic silicon compound used.

The inorganic filler surface-treated with the nonreactive organic silicon compound is normally used in an amount of 1 to 20 parts by mass, preferably 3 to 15 parts by mass with respect to 100 parts by mass of the component (A). An amount below such lower limit makes it difficult to restrict the composition from protruding from the edge portion of the heatsink. In contrast, an amount beyond such upper limit leads to an excessively high viscosity such that a flowability of the epoxy resin composition may decrease to a level where it becomes difficult to obtain a liquid epoxy resin composition.

### (Other Components)

In order to reduce the stress of the cured product, there may be further added to the composition of the present invention a flexible resin such as a silicone rubber, a liquid polybutadiene rubber and a methyl methacrylate-butadiene-styrene copolymer; a curing accelerator, a silane coupling agent; a pigment such as carbon black; a dye; and an antioxidant, in an amount(s) not impairing the effects of the present invention.

### (Preparation Method of Adhesive Composition)

The composition of the present invention is obtained by simultaneously or separately stirring, melting, mixing and dispersing the components (A) to (F) and the other components as desired, while performing a heating treatment if necessary. Although no particular limitations are imposed on the apparatuses used to perform these operations, there may be used a kneader (mortar machine) equipped with a stirring and heating devices, a triple roll mill, a ball mill, a planetary mixer and the like. Further, these apparatuses may also be appropriately used in combination.

The adhesive composition of the present invention that is obtained through the aforementioned preparation method has the following feature. That is, the resin composition exhibits a viscosity of 50 to 1,000 Pa·s, preferably 50 to 500 Pa·s when measured by an E-type viscometer at 25° C. As for a curing condition of such adhesive composition, it is preferred that oven curing be performed at 100 to 120° C. for not less than 0.5 hours in the beginning, and then at 150 to 175° C. for not less than 2 hours. Here, voids may be formed after curing, if heating at the temperature of 100 to 120° C. is performed for less than 0.5 hours. Further, there may not be achieved a sufficient cured product property, if heating at the temperature of 150 to 175° C. is performed for less than 0.5 hours.

### Working Example

The present invention is described in detail hereunder with reference to working and comparative examples.

### (Preparation of Adhesive Composition)

Adhesive compositions of working examples 1 to 6 and comparative examples 1 to 9 were obtained by homogeneously kneading the components of the particular amounts (parts by mass) shown in Table 1, using a triple roll mill. The components in Table 1 are as follows.

### (A) Epoxy Resin

Epoxy resin A1: Bisphenol F-type epoxy resin (ZX1059 by TOHTO Chemical Industry Co., Ltd.)

Epoxy resin A2: Trifunctional epoxy resin indicated by the following formula (8) (jER630 by Mitsubishi Chemical Corporation)

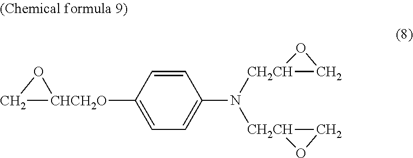

Epoxy resin A3: Naphthalene-type epoxy resin (HP4032D by DIC Corporation)

### (B) Liquid Phenol Curing Agent

Curing agent B1: Allyl phenol novolac (MEH-8000H by Meiwa plastic industries, Ltd.)

### Viscosity: 1.5 Pa·s

Curing agent B2: Phenol curing agent Phenol-based curing agent (Compound indicated by the following formula (9) (n=0 to 4, R¹ and R² are allyl groups))

### Viscosity: 3 Pa·s

Curing agent B3: Phenol curing agent Phenol-based curing agent (Compound indicated by the following formula (9) (n=5 to 7, R¹ and R² are allyl groups))
Viscosity: 800 Pa·s (Curing agent for comparison)
Curing agent B4: Phenol curing agent Phenol-based curing agent (Compound indicated by the following formula (9) (n=8 to 10, R¹ and R² are allyl groups))
Solid at 25° C. (Curing agent for comparison)

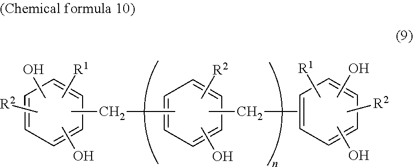

Curing agent B5: Acid anhydride mixture indicated by the following formula (10) (MH700 by New Japan Chemical Co., Ltd.) (Curing agent for comparison)

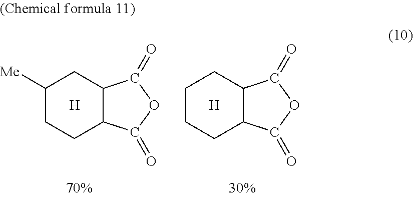

Curing agent B6: Phenol resin having siloxane bond (Curing agent for comparison)

Azeotropic dehydration was performed at 130° C. for 2 hours, by placing into a flask 30.8 g (0.10 mol) of the phenol resin indicated by the following formula (11) and 123.2 g of toluene. Here, the flask was equipped with a stirring blade(s), a dripping funnel, a thermometer, an ester adapter and a reflux tube. A product thus obtained was then cooled to 100° C., and 0.5 g of a catalyst (CAT-PL-50T by Shin-Etsu Chemical Co., Ltd.) was further delivered by drops thereinto, followed by immediately delivering a mixture of 110.3 g (0.05 mol) of the organopolysiloxane indicated by the following formula (12) and 441.2 g of toluene by drops thereinto within about 30 min, and then maturing the same at 100° C. for 6 hours. Toluene was then removed therefrom to obtain a brown transparent liquid (η=10 Pa·s/25° C.; Phenol equivalent 720; Organopolysiloxane amount 78.2 parts by weight).

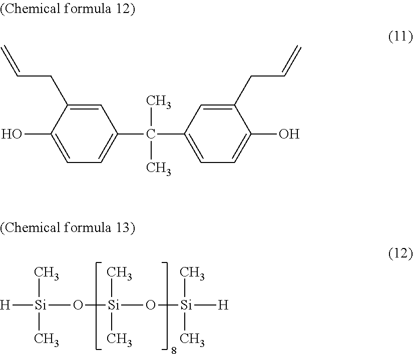

### (C) Curing Accelerator

Curing accelerator C1: 2-phenyl-4,5-dihydroxymethylimidazole powder with an average particle diameter of 4.2 μm and a maximum particle diameter of not larger than 15 μm (Imidazole 2PHZ-PW by Shikoku Chemicals Corporation) (Purity 95%)

Curing accelerator C2: triphenylphosphine (TPP) (Curing accelerator for comparison)

### (D) Inorganic Filler

Silica D1: Spherical silica with a maximum particle diameter of not larger than 53 μm and an average particle diameter of 7 μm (product by Tatsumori Ltd. and previously surface-treated with a silane coupling agent (N-phenyl-3-aminopropyltrimethoxysilane, KBM573 by Shin-Etsu Chemical Co., Ltd)).

Silica D2: Spherical silica with a maximum particle diameter of not larger than 53 μm and an average particle diameter of 7 μm (product by Tatsumori Ltd., with no surface treatment) (inorganic filler for comparison)
(E) Thermoplastic resin particles: polymethylmethacrylate, number average molecular weight 50,000, weight-average molecular weight 150,000, average particle diameter 1 μm, maximum particle diameter 3 μm.

### (F) Surface-Silylated Silica

Silica F1: Treated silica of an average particle diameter (d₅₀) of 0.008 μm, treated with {(CH₃)₃Si}₂NH and CH₃CH₂Si(OCH₃)₃
Silica F2: Treated silica (surface-silylated silica for comparison) of an average particle diameter (d₅₀) of 0.008 μm, previously surface-treated with a silane coupling agent (N-phenyl-3-aminopropyltrimethoxysilane, KBM573 by Shin-Etsu Chemical Co., Ltd)

### Other Components

Silane coupling agent: γ-glycidoxypropyltrimethoxysilane (KBM 403 by Shin-Etsu Chemical Co., Ltd)

Copolymer: (Product obtained by addition reaction between the silicone-modified epoxy resin of the following formula (13) and the organopolysiloxane of the following formula (14))

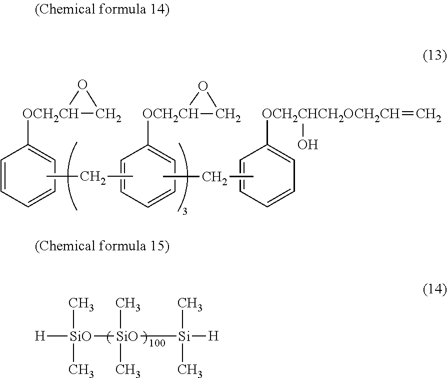

As for the curable silicone rubbers used in the comparative examples 10 and 11, the components of the particular amounts (parts by mass) shown in Table 1 were prepared through the following method.

Water of 100 parts by mass, and then an acetic acid aqueous solution of 60% by weight and 20 parts by mass were successively mixed into a solution obtained by dissolving 2 parts by mass of γ-glycidoxypropyltrimethoxysilane into 50 parts by mass of methanol. A mixed liquid thus prepared was then subjected to ultrasonic vibration for an hour to obtain a silane solution. A planetary mixer was then used to mix, for an hour, this silane solution; the silica D1 of either 150 parts by mas (comparative example 10) or 400 parts by mass (comparative example 11); and a linear dimethylpolysiloxane of an amount of 100 parts by mass, the linear dimethylpolysiloxane being indicated by the following formula (15) and having both terminal ends of its molecular chain blocked by dimethylvinylsilyl groups. A mixture thus obtained was then kneaded using a triple roll mill.

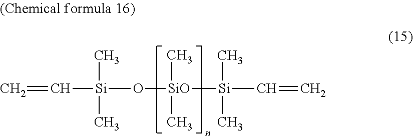

(In the formula, n is a number allowing this siloxane to exhibit a viscosity of 400 mm²/s at 25° C.)

Next, methylhydrogensiloxane (amount of hydrogen atoms bonded to silicon atoms: 0.8 mol/100 g) of 5.1 parts by mass and an octyl alcohol modified solution of platinic chloride (amount of platinum: 2% by weight) of 0.02 parts by mass, were added to and stirred together with a kneaded product obtained as above, thereby obtaining the composition of the present invention.

Each composition was evaluated as follows.

### (Viscosity of Cured Product)

As for each composition, a viscosity was measured in accordance with JIS Z 8803 and using an E-type viscometer (HBDV-III by Brookfield Engineering Laboratories, Inc.). Particularly, the viscosity was measured 2 minutes after rotation had started, and at a temperature of 25° C. and a shear rate of 2.00 (sec⁻¹).

### (Expansion Ratio of Resin)

A ratio of a height and diameter of the cured product (h/d) was employed as an index of a shape maintaining property of the composition. Such aspect ratio was measured as follows. As shown in FIG. 3, 0.1 g of the composition was placed on a glass plate 11 (1 mm thick). Five minutes later, the glass plate 11 was then mounted on a hot plate (not shown) that had been previously set to 120° C. After the composition had been cured, a cured product 12 thus obtained was then cooled, followed by measuring the height (h) and diameter (d) of the cured product 12 to obtain the ratio of the height and diameter of such cured product (h/d).

### (Tensile Elastic Modulus)

The composition was cured by heating the same at 150° C. for 3 hours, followed by measuring a tensile elastic modulus thereof in accordance with JIS K 7161.

### (Glass Transition Temperature and Expansion Coefficient)

A glass transition temperature (Tg), an expansion coefficient at or lower than Tg (CTE-1), and an expansion coefficient at or higher than Tg (CTE-2) of the adhesive composition were obtained as follows.

After curing the composition by heating the same at 150° C. for 3 hours, the cured product was then cooled to a normal temperature, followed by cutting such cured product into specimens of a size of 5 mm×5 mm×15 mm. A thermal mechanical analyzer (TMA) was then used to measure an amount of thermal expansion when the temperature had increased from a room temperature to 300° C. at a rate of 5° C./min. Based on such measured results, there were obtained the glass transition temperature; CTE-1 within a temperature range of 20 to 50° C.; and CTE-2 within a temperature range of 200 to 230° C.

### (Adhesion)

A truncated cone-shaped resin composition specimen was placed on a nickel-coated copper plate. Particularly, this specimen had an upper surface diameter of 2 mm; a lower surface diameter of 5 mm; and a height of 3 mm. After the specimen had been cured, a shearing adhesion thereof was measured, and a measured value thus obtained was regarded as an initial value. In addition, the cured specimen was also left for 168 hours in a thermo-hygrostat of 85° C. and 85% RH, and was then put through an IR reflow oven three times where a maximum temperature was 260° C. An adhesion of the specimen thus deteriorated was then measured. In each case, there were used 5 specimens, and an average value thereof was noted as adhesion.

### (Thermal Resistance Value)

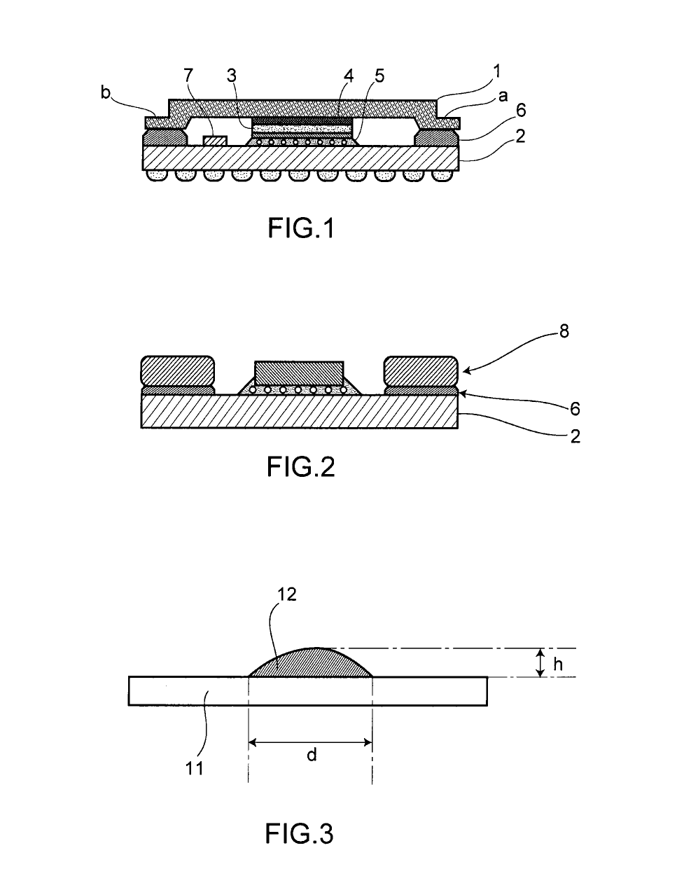

There was assembled a device shown in FIG. 1. Specifically, a silicon chip CPU 3 (Celeron 300A, 15 mm×15 mm×0.75 mm) was joined to a CPU substrate 2 (38 mm×38 mm×2 mm) through flip-chip bonding, followed by encapsulating the same with an underfill material 5 (SMC-377S by Shin-Etsu Chemical Co., Ltd.). A heat dissipation material (TIM 7772-4 by Shin-Etsu Chemical Co., Ltd.) was then dispensed on the silicon chip 3, and each adhesive composition was dispensed on the substrate 2 in an amount of about 1.0 g. Next, a heatsink 1 (Ni-coated copper plate, 1 WPC) of a size of 38 mm×38 mm×2 mm was mounted on the silicon chip 3 to cure the composition by heating the same at 150° C. for 3 hours. Further, a thermocouple was later arranged in locations “a” and “b” that are shown in FIG. 1, followed by operating the silicon chip 3 at 450 MHz/power consumption 25.6 W. A thermal resistance value was then calculated using the following formula as an operation rate had reached 100%.

Thermal resistance of heat dissipation material Rja (° C./W)=(silicon chip temperature−heatsink temperature)/25.6

### (Thermal Resistance Value Following Thermal Cycle)

After having its thermal resistance value measured, the device was then subjected to a 500-cycle test of which each cycle was made up of −45° C. for 15 min and then 125° C. for 15 min. The thermal resistance value of the device was measured as above, after performing the 500-cycle test.

### (Warpage of Package)

After having its thermal resistance value measured, a warpage of the device was then measured using a laser measuring device (Device name: temperature variable laser three-dimensional displacement measurement apparatus LS150-RTH60 by T-Tech)

The above working and comparative examples are all summarized in Table 1.

TABLE 1

| | | Working example | | | | | | Comparative example | |
|---|---|---|---|---|---|---|---|---|---|
| | | 1 | 2 | 3 | 4 | 5 | 6 | 1 | 2 |
| A) Epoxy resin | Epoxy A1: ZX1059 | 50 | 21.5 | 23.5 | 57.7 | 25.6 | 28.3 | 50 | 46 |
| | Epoxy A2: JER630 | | 21.5 | | | 25.6 | | | |
| | Epoxy A3: HP4032D | | | 23.5 | | | 28.3 | | |
| B) Curing agent | Curing agent B1 | 45 | 52 | 48.1 | | | | 45 | |
| | Curing agent B2 | | | | 37.3 | 43.7 | 38.5 | | |
| | Curing agent B3 | | | | | | | | |
| | (for comparison) | | | | | | | | |
| | Curing agent B4 | | | | | | | | |
| | (for comparison) | | | | | | | | |
| | Curing agent B5 | | | | | | | | 49 |
| | (for comparison) | | | | | | | | |
| | Curing agent B6 | | | | | | | | |
| | (Siloxane bond) | | | | | | | | |
| C) Curing accelerator | Curing accelerator | 1 | 1 | 1 | 1 | 1 | 1 | 1 | 1 |
| | C1: 2PHZ-PW | | | | | | | | |
| | Curing accelerator | | | | | | | | |
| | C2: TPP (for comparison) | | | | | | | | |
| D) Inorganic filler | Silica D1 | 150 | 150 | 150 | 150 | 150 | 150 | 150 | 150 |
| | Silica D2 (for comparison) | | | | | | | | |
| E) Thermoplastic resin | polymethylmethacrylate | 5 | 5 | 5 | 5 | 5 | 5 | 0 | 5 |
| F) Inorganic filler | Silica F1 | 5 | 5 | 5 | 5 | 5 | 5 | 5 | 5 |
| surface-treated with | Silica F2 (for comparison) | | | | | | | | |
| silane coupling agent | | | | | | | | | |
| having nonreactive | | | | | | | | | |
| functional group | | | | | | | | | |
| Additive | Copolymer | 5 | 5 | 5 | 5 | 5 | 5 | 5 | 5 |
| | KBM403 | 1 | 1 | 1 | 1 | 1 | 1 | 1 | 1 |
| Basic physical | Viscosity (Pa · s) | 100 | 75 | 140 | 125 | 103 | 160 | 88 | 49 |
| property | Resin expansion ratio | 0.48 | 0.44 | 0.51 | 0.43 | 0.45 | 0.45 | 0.45 | 0.5 |
| | Elastic modulus (MPa) | 8,600 | 8,800 | 8,400 | 9,000 | 9,100 | 8,900 | 9,000 | 8,500 |
| | Glass transition | 70 | 90 | 72 | 80 | 97 | 83 | 71 | 125 |
| | temperature Tg (° C.) | | | | | | | | |
| | CTE1 (ppm/° C.) | 37 | 36 | 35 | 36 | 35 | 36 | 36 | 33 |
| | CTE2 (ppm/° C.) | 105 | 100 | 98 | 100 | 97 | 97 | 101 | 95 |
| Adhesion | Initial (MPa) | 15 | 18 | 18 | 18 | 22 | 20 | 11 | 8 |
| | Post-deterioration (MPa) | 11 | 12 | 13 | 15 | 17 | 16 | 0 | 0 |
| Thermal resistance value | Rja (° C./W) | 0.15 | 0.14 | 0.18 | 0.18 | 0.14 | 0.15 | 0.14 | 0.13 |
| Thermal resistance value | Rja (° C./W) | 0.16 | 0.18 | 0.19 | 0.18 | 0.21 | 0.17 | Unmeasurable | |
| following thermal cycle | | | | | | | | due to peeling | |
| Warpage | μ | −135 | −127 | −133 | −120 | −115 | −120 | −140 | −115 |

| | | Comparative example | | | | | | | | |
|---|---|---|---|---|---|---|---|---|---|---|
| | | 3 | 4 | 5 | 6 | 7 | 8 | 9 | 10 | 11 |
| A) Epoxy resin | Epoxy A1: ZX1059 | 53.6 | 48 | 50 | 53 | 57 | 50 | 50 | Curable | |
| | Epoxy A2: JER630 | | | | | | | | silicone | |
| | Epoxy A3: HP4032D | | | | | | | | rubber | |
| B) Curing agent | Curing agent B1 | | | 45 | 33 | | 45 | 45 | | |
| | Curing agent B2 | | | | | | | | | |
| | Curing agent B3 | 41.4 | | | | | | | | |
| | (for comparison) | | | | | | | | | |
| | Curing agent B4 | | 47 | | | | | | | |
| | (for comparison) | | | | | | | | | |
| | Curing agent B5 | | | | | | | | | |
| | (for comparison) | | | | | | | | | |
| | Curing agent B6 | | | | 8 | 37 | | | | |
| | (Siloxane bond) | | | | | | | | | |
| C) Curing accelerator | Curing accelerator | 1 | | | 1 | 1 | 1 | 1 | | |
| | C1: 2PHZ-PW | | | | | | | | | |
| | Curing accelerator | | | 1 | | | | | | |
| | C2: TPP (for comparison) | | | | | | | | | |
| D) Inorganic filler | Silica D1 | 150 | 150 | 150 | 150 | 150 | | 150 | 150 | 400 |
| | Silica D2 (for comparison) | | | | | | 150 | | | |
| E) Thermoplastic resin | polymethylmethacrylate | 5 | 5 | 5 | 5 | 5 | 5 | 5 | 5 | 5 |
| F) Inorganic filler | Silica F1 | 5 | 5 | 5 | 5 | 5 | 5 | | | |
| surface-treated with | Silica F2 (for comparison | | | | | | 5 | 5 | | |
| silane coupling agent | | | | | | | | | | |
| having nonreactive | | | | | | | | | | |
| functional group | | | | | | | | | | |
| Additive | Copolymer | 5 | 5 | 5 | 5 | 5 | 5 | 5 | | |
| | KBM403 | 1 | 1 | 1 | 1 | 1 | 1 | 1 | | |

| | | | | | | | | | |
|---|---|---|---|---|---|---|---|---|---|
| Basic physical | Viscosity (Pa · s) | Not shapable | 280 | 86 | 75 | 240 | 82 | 28 | 70 |
| property | Resin expansion ratio | due to high | 0.52 | 0.42 | 0.36 | 0.68 | 0.12 | 0.25 | 0.45 |
| | Elastic modulus (MPa) | viscosity | 5,900 | 4,200 | 2,300 | 8,900 | 8,500 | 50 | 150 |
| | Glass transition | | 55 | 50 | 25 | 73 | 72 | — | — |
| | temperature Tg (° C.) | | | | | | | | |
| | CTE1 (ppm/° C.) | | 60 | 50 | 70 | 38 | 37 | — | — |
| | CTE2 (ppm/° C.) | | 170 | 150 | 200 | 101 | 106 | — | — |
| Adhesion | Initial (MPa) | | 3 | 10 | 5 | 12 | 14 | 5 | 8 |
| | Post-deterioration (MPa) | | 0 | 0 | 0 | 0 | 10 | 5 | 8 |
| Thermal resistance value | Rja (° C./W) | | 0.22 | 0.18 | 0.25 | 0.18 | 0.16 | 0.36 | 0.33 |
| Thermal resistance value | Rja (° C./W) | | 0.35 | 0.21 | 0.59 | 0.19 | 0.15 | 0.75 | 0.55 |
| following thermal cycle | | | | | | | | | |
| Warpage | μ | | −140 | −135 | −180 | −170 | −140 | −250 | −228 |

As for working examples 1 to 6, since an adhesion after deterioration was still maintained at a value of at least 11 MPa, there existed a high reflow resistance. Further, since the thermal resistance value measured after the thermal cycle was restricted to a low level, it can be learned that there existed a high reliability. In contrast, as for comparative examples 1 to 8 except comparative examples 3 and 4 where a forming incapability was observed, since no adhesion (i.e. an adhesion of 0 MPa) was exhibited after deterioration, and since the thermal resistance values obtained following the thermal cycle had significantly decreased or become those causing peeling, it can be learned that there existed a low reliability. Further, as for comparative example 9, the adhesion after deterioration was 10 MPa, and almost no difference was observed between a thermal resistance value measured before the thermal cycle and that measured following the thermal cycle. However, since the resin expansion ratio was low in comparative example 9, a problematic workability was achieved. Moreover, since the warpage value was also observed to be higher than those of the working examples, it can be learned that there exited a low reliability as a whole. As for comparative examples 10 and 11, although there was observed no change in the adhesion before and after performing reflow, there were confirmed low adhesions; significant changes in the thermal resistance value before and after the thermal cycle; and significant warpages. Thus, it can be learned that the samples of comparative examples 10 and 11 exhibited low reliabilities.

### INDUSTRIAL APPLICABILITY

The liquid epoxy resin composition of the present invention; and the adhesive agent for a heatsink and stiffener of the present invention, are superior in adhesion and reflow resistance, and are thus effective when used to adhere a heatsink or stiffener to a chip at the time of performing semiconductor chip packaging. The adhesive agent of the present invention is effective in improving a heat-dissipation management property of a flip chip-type semiconductor device.

What is claimed:

1. A liquid epoxy resin composition exhibiting a viscosity of 50 to 1,000 Pa·s when measured by an E-type viscometer at 25° C., comprising:
(A) at least one liquid epoxy resin selected from the group consisting of a bisphenol A-type epoxy resin, a bisphenol F-type epoxy resin, a naphthalene type epoxy resin and an epoxy resin represented by the following formula (1): 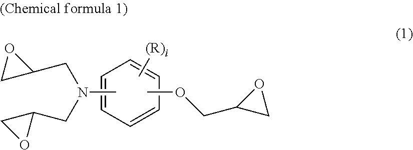
(wherein R groups are either identical to or different from each other, and each represent a hydrogen atom, a halogen atom, a substituted or unsubstituted monovalent hydrocarbon group having 1 to 6 carbon atoms, an alkoxy group or an aryl group; i represents an integer of 0 to 3), said liquid epoxy resin being in an amount of 100 parts by mass and exhibiting a viscosity of 0.1 to 1,000 Pa·s when measured by the E-type viscometer at 25° C.;
(B) a liquid phenol-based curing agent having no siloxane bond and exhibiting an viscosity of 0.1 to 100 Pa·s when measured by the E-type viscometer at 25° C., said liquid phenol-based curing agent being in an amount of 40 to 130 parts by mass with respect to 100 parts by mass of said liquid epoxy resin as the component (A);
(C) a curing accelerator selected from the group consisting of tetraphenylphosphine, imidazole and tertiary amine, said curing accelerator being in an amount of 0.1 to 20 parts by mass with respect to 100 parts by mass of said liquid epoxy resin as the component (A);
(D) an inorganic filler treated with a silane coupling agent and having an average particle diameter of not smaller than 0.1 μm, said inorganic filler being in an amount of 50 to 500 parts by mass with respect to 100 parts by mass of said liquid epoxy resin as the component (A);
(E) thermoplastic resin particles that are solid at 25° C., said thermoplastic resin particles being in an amount of 3 to 50 parts by mass with respect to 100 parts by mass of a sum of the components (A) and (B); and
(F) a silica treated with a silane coupling agent having a nonreactive functional group, said silica being in an amount of 1 to 20 parts by mass with respect to 100 parts by mass of said liquid epoxy resin as the component (A) and having an average particle diameter of not smaller than 0.005 μm but smaller than 0.1 μm.

2. The liquid epoxy resin composition according to claim 1, further comprising a silicone-modified epoxy resin represented by the following formula (2): 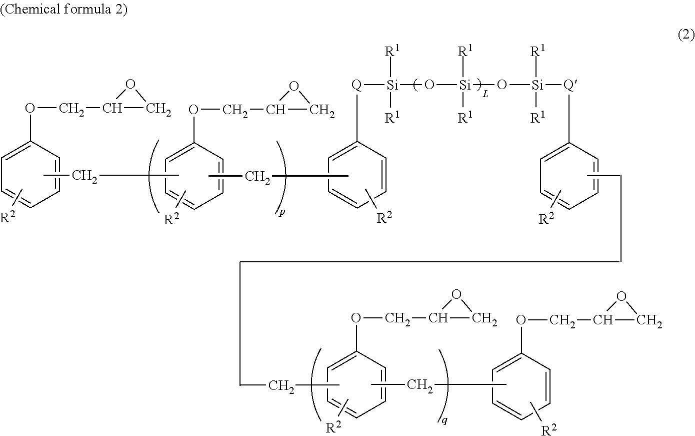
(wherein R¹ represents a substituted or unsubstituted monovalent hydrocarbon group having 1 to 10 carbon atoms; R² represents a hydrogen atom or a monovalent hydrocarbon group having 1 to 6 atoms; Q represents —CH₂CH₂CH₂—, —OCH₂—CH(OH)—CH₂—O—CH₂CH₂CH₂— or —O—CH₂CH₂CH₂—; Q′ represents —CH₂CH₂CH₂—, —CH₂CH₂CH₂O—CH₂—CH(OH)—CH₂—O— or —CH₂CH₂CH₂—O—; L represents an integer of 8 to 398, p represents an integer of 1 to 10, and q represents an integer of 1 to 10), said silicone-modified epoxy resin being in an amount of 0 to 20 parts by mass with respect to 100 parts by mass of said liquid epoxy resin as the component (A).

3. The liquid epoxy resin composition according to claim 1, wherein said (B) liquid phenol-based curing agent comprises at least one of the curing agents represented by the following formulas (3) and (4): 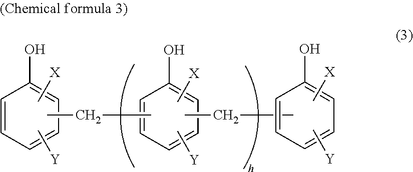
(wherein X represents a hydrogen atom or a monovalent hydrocarbon group having 1 to 6 carbon atoms; Y represents a hydrogen atom or an allyl group; and h represents an integer of 0 to 50); 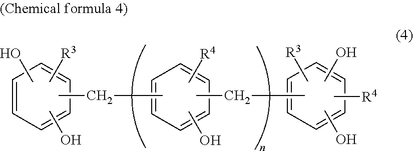
(wherein R³ and R⁴ each represent a hydrogen atom; and a monovalent group selected from an alkyl group, an aryl group, an allyl group and a vinyl group each having 1 to 10 carbon atoms. n represents an integer of 0 to 10).

4. The liquid epoxy resin composition according to claim 1, wherein said curing accelerator as the component (C) comprises an imidazole derivative represented by the following formula (5): 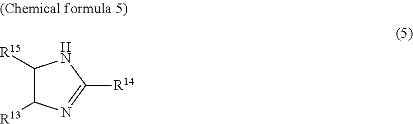
(wherein each of R¹³, R¹⁴ and R¹⁵ represents a hydrogen atom; or a monovalent hydrocarbon group that has 1 to 10 carbon atoms and may contain an oxygen atom, nitrogen atom and sulfur atom).

5. The liquid epoxy resin composition according to claim 4, wherein said imidazole derivative as the component (C) comprises a compound of the following formula (6): 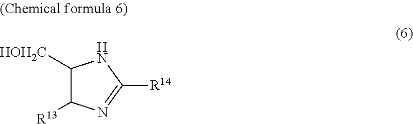
(wherein R¹³ represents a hydrogen atom; or a monovalent hydrocarbon group that has 1 to 10 carbon atoms and may contain an oxygen atom, nitrogen atom and sulfur atom; R¹⁴ represents a hydrogen atom; or a monovalent hydrocarbon group that has 1 to 10 carbon atoms but does not contain any of oxygen atom, nitrogen atom and sulfur atom).

6. The liquid epoxy resin composition according to claim 1, wherein said (D) inorganic filler comprises at least one of molten silica, crystalline silica, alumina, titanium oxide, silica titania, boron nitride, aluminum nitride, silicon nitride, magnesia, magnesium silicate and aluminum.

7. The liquid epoxy resin composition according to any one of claim 1, wherein said (E) thermoplastic resin particles that are solid at 25° C. are selected from the group consisting of methacrylic resin particles, phenoxy resin particles, butadiene resin particles, polystyrene particles and copolymers thereof.

8. A lid adhesive agent or a stiffener adhesive agent for a flip chip-type semiconductor, which is made of the liquid epoxy resin composition of claim 1.

9. A flip chip-type semiconductor device including the lid adhesive agent or a stiffener adhesive agent of claim 8.
